(19) United States
(12) Patent Application Publication
(10) Pub. No.: US 2026/0007913 A1
(43) Pub. Date: Jan. 8, 2026

(54) APPARATUS FOR EXTINGUISHING ELECTRIC BUS FIRES

(71) Applicant: TANKTECH CO., LTD., Busan (KR)

(72) Inventors: Joo Ha AN, Busan (KR); Do Wan KIM, Busan (KR); Sun Jae KIM, Busan (KR); Tae Ho JI, Busan (KR); Young Han KIM, Busan (KR); Deok Won KIM, Busan (KR)

(21) Appl. No.: 18/916,968

(22) Filed: Oct. 16, 2024

(30) Foreign Application Priority Data
Jul. 3, 2024 (KR) 10-2024-0087829

(51) Int. Cl. A62C 27/00; A62C 31/22; A62C 31/28

(52) U.S. Cl. CPC A62C 27/00; A62C 31/22; A62C 31/28

(57) ABSTRACT

Proposed is an apparatus for extinguishing electric bus fires, including a fire water tank provided in a transport vehicle, a foldable frame configured to unfold or fold using hydraulic pressure, and a fire water injection lance configured to puncture a battery placed on a roof of an electric bus and inject fire extinguishing water into the battery.

### CROSS REFERENCE TO RELATED APPLICATION

The present application claims priority to Korean Patent Application No. 10-2024-0087829, filed Jul. 3, 2024, the entire contents of which are incorporated herein for all purposes by this reference.

### BACKGROUND

### Technical Field

The present disclosure relates to an apparatus for extinguishing electric bus fires and, more particularly, to an apparatus for extinguishing electric bus fires, wherein the apparatus is easy to transport by vehicle due to the foldable structure thereof, and enables rapid fire suppression by hydraulically puncturing a battery mounted on the roof of an electric bus and injecting fire extinguishing water while in close contact with the electric bus where a fire broke out.

### Description of the Related Art

Recently, as the number of registered electric vehicles (EVs) in Korea is increasing and major public transportation such as taxis and buses are converted to electric propulsion, the development of safety measures in response to EV-related fires is emerging as an urgent issue as electric vehicle fires are frequent and cannot be extinguished easily due to the characteristics of electric vehicle batteries.

Electric buses, in particular, have high-capacity batteries placed on the roof thereof, and if the batteries start to ignite due to an accident or other various reasons, it is difficult to extinguish the fire because the temperature of the heating point is very high and continuous heat transfer occurs due to the high-density integrated form of a battery, causing re-ignition.

When a battery of an electric bus catches fire, putting out the fire is difficult and the fire easily re-ignites until the battery is completely burnt, and thus large amounts of fire extinguishing water need to be continuously injected in for a long period of time to extinguish the fire.

The most effective fire extinguishing method to solve this problem would be to lift an electric car that caught fire using a crane and submerge the car in water in a water tank to extinguish the fire. However, in the case of electric buses, it is difficult to apply this method due to their weight and size.

### SUMMARY

Accordingly, the present disclosure has been made keeping in mind the above problems occurring in the related art, and the present disclosure is intended to provide an apparatus for extinguishing electric bus fires, wherein the apparatus is easy to transport by vehicle due to the foldable structure thereof, and enables rapid fire suppression by hydraulically puncturing a battery mounted on the roof of an electric bus and injecting fire extinguishing water while in close contact with the electric bus where a fire broke out.

In order to achieve the above objective, according to an embodiment of the present disclosure, there is provided an apparatus for extinguishing electric bus fires, the apparatus including: a fire water tank 110 provided in a transport vehicle; a foldable frame 120 configured to unfold or fold using hydraulic pressure; and a fire water injection lance 130 disposed on the foldable frame 120, and configured to puncture a battery placed on a roof of an electric bus and inject fire extinguishing water supplied from the fire water tank 110 into the battery, wherein the foldable frame 120 may be positioned, while unfolded, adjacent to a side of the electric bus, and with the foldable frame 120 fixed to the side of the electric bus, the fire water injection lance 130 may puncture the battery placed on the roof of the electric bus by using the hydraulic pressure and inject the fire extinguishing water into the battery to extinguish a fire.

The foldable frame 120 according to an embodiment of the present disclosure may include: a lower frame 121; an upper frame 122 connected to the lower frame 121 with a hinge so that a side thereof can be rotated; a folding cylinder 123 connected between the lower frame 121 and the upper frame 122 and configured to control a rotation of the upper frame 122 by using the hydraulic pressure; an upper fixing frame 124 connected to the upper frame 122 with a hinge so that a side thereof can be rotated, and in close contact with a top surface of the electric bus; an upper fixing cylinder 125 connected between the upper frame 122 and the upper fixing frame 124, and configured to control a rotation of the upper fixing frame 124 by using the hydraulic pressure; a lower fixing frame 126 connected to the lower frame 121 with a hinge so that a side thereof can be rotated, and in close contact with a bottom surface of the electric bus; a lower fixing cylinder 127 connected between the lower frame 121 and the lower fixing frame 126, configured to control a rotation of the lower fixing frame 126 by using the hydraulic pressure; and a puncturing cylinder 128 disposed at an end of the upper fixing frame 124, and configured to push the fire water injection lance 130 located at a top of the electric bus toward the battery.

The foldable frame 120 according to an embodiment of the present disclosure may further include: a mounting part 129 provided to be adjustable in height up and down while connected to a side of the lower frame 121, and a side of which is mounted on the transport vehicle through a locking connection.

The mounting part 129 according to an embodiment of the present disclosure may include: a locking means for mounting 129-1 having a ring shape so as to be mounted on the transport vehicle; and a mounting cylinder 129-2 connected between the lower frame 121 and the locking means for mounting 129-1, and configured to adjust a vertical height of the locking means for mounting 129-1 by using the hydraulic pressure.

The folding cylinder 123, the upper fixing cylinder 125, the lower fixing cylinder 127, the puncturing cylinder 128, and the mounting cylinder 129-2 according to an embodiment of the present disclosure may be connected to a hydraulic pump 200 disposed on a side of the transport vehicle through a hydraulic pressure supply line and controlled by means of the hydraulic pressure.

By means of the hydraulic pressure supplied from the hydraulic pump 200 according to an embodiment of the present disclosure, the folding cylinder 123, the upper fixing cylinder 125, the lower fixing cylinder 127, the puncturing cylinder 128, and the mounting cylinder 129-2 may be each independently controlled.

The fire water injection lance 130 according to an embodiment of the present disclosure may be connected to a fire water pump 300 disposed on a side of the fire water tank 110 through a fire water supply line and may receive the fire extinguishing water.

The fire water injection lance 130 according to an embodiment of the present disclosure may include: a lance head 131 configured to puncture an upper side of the battery by using the hydraulic pressure; and a fire water nozzle 132 provided on a side of a body of the fire water injection lance 130 and configured to eject the fire extinguishing water outward, wherein the lance head 131 may be connected to be replaceable from the body of the fire water injection lance 130. The body of the fire water injection lance 130 according to an embodiment of the present disclosure may be formed in multiple stages, and the fire water nozzle 132 is disposed in each stage.

According to the present disclosure, it is possible to swiftly extinguish a fire by hydraulically puncturing a battery mounted on the roof of an electric bus and injecting fire extinguishing water while an apparatus of the present disclosure is in close contact with the electric bus where the fire broke out.

Furthermore, according to the present disclosure, the foldable structure not only minimizes the size of the apparatus of the present disclosure during storage and transportation, but also allows the apparatus to be easily and conveniently transported to a fire scene by mounting the apparatus on the back of a transport vehicle (e.g., truck, etc.)

Furthermore, according to the present disclosure, since the apparatus is tightly fixed to the top and bottom surfaces of an electric bus, in the process of puncturing a battery by using hydraulic pressure and injecting high-pressure fire extinguishing water into the battery, a fire water injection lance does not fall out or separate, allowing stable fire suppression.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view showing the overall configuration of an apparatus 100 for extinguishing electric bus fires according to an embodiment of the present disclosure;

FIG. 2 is a view showing the apparatus 100 for extinguishing electric bus fires of FIG. 1 mounted on a transport vehicle;

FIG. 3 is a view showing the configuration of a foldable frame 120 in more detail;

FIGS. 4A and 4B are views showing a state in which an upper frame 122 is rotated from a lower frame 121 by a folding cylinder 123;

FIGS. 5A and 5B are views showing a state in which an upper fixing frame 124 is rotated from the upper frame 122 by an upper fixing cylinder 125 and is in close contact with the top of an electric bus;

FIGS. 6A and 6B are views showing a state in which a lower fixing frame 126 is rotated from the lower frame 121 by a lower fixing cylinder 127 and is in close contact with the bottom of the electric bus;

FIGS. 7A and 7B are views showing a state in which a fire water injection lance 130 is inserted toward the inside of a battery by a puncturing cylinder 128 to puncture the battery;

FIGS. 8A and 8B are views showing a state in which the height of a locking means for mounting 129-1 is adjusted up and down from the lower frame 121 by a mounting cylinder 129-2;

FIGS. 9A and 9B are views showing the fire water injection lance 130 in more detail; and

FIG. 10 is a view sequentially showing the process of extinguishing a fire in an electric bus battery using the apparatus 100 for extinguishing electric bus fires.

### DETAILED DESCRIPTION

Hereinafter, specific details for implementing the present disclosure will be described in detail with reference to the attached drawings.

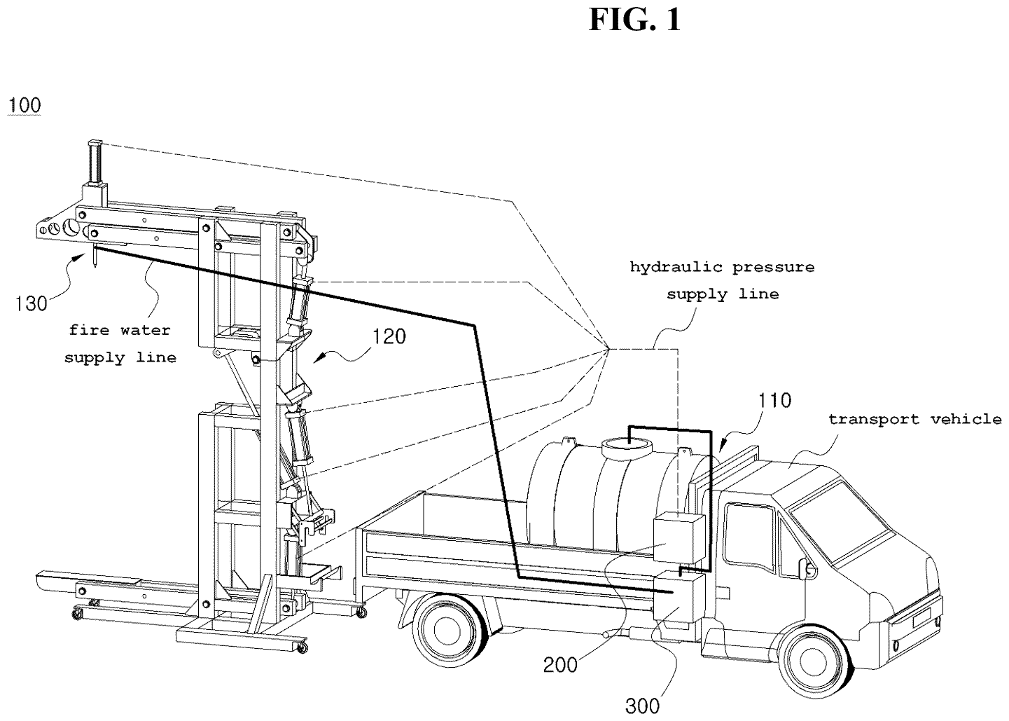

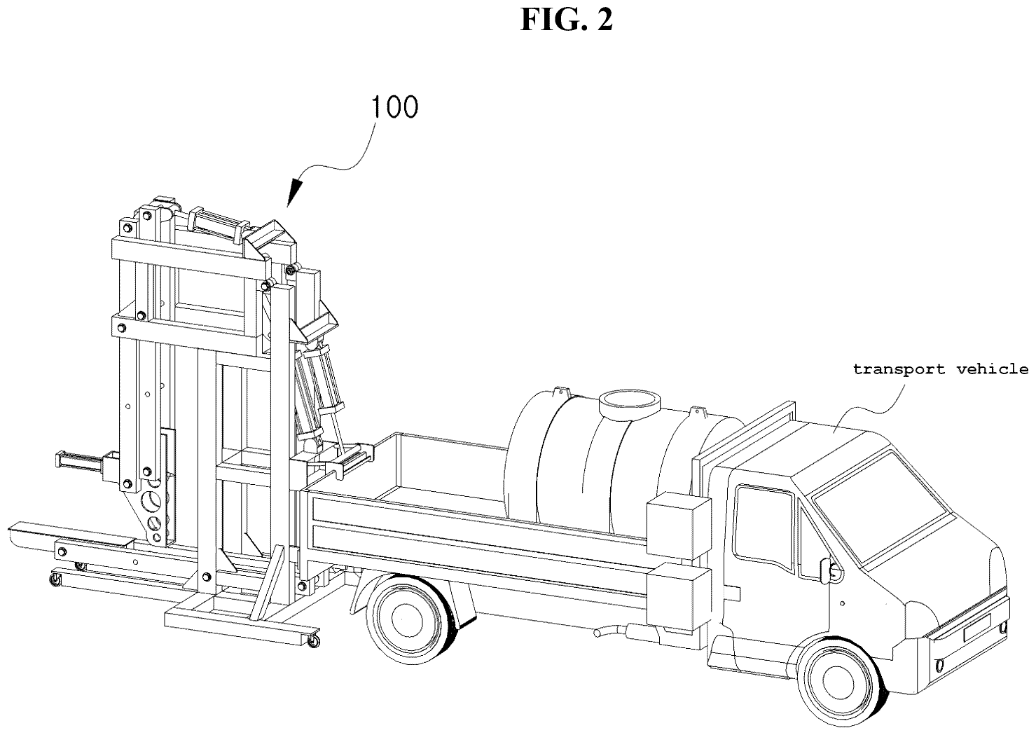

FIG. 1 is a view showing the overall configuration of an apparatus 100 for extinguishing electric bus fires according to an embodiment of the present disclosure, and FIG. 2 is a view showing the apparatus 100 for extinguishing electric bus fires of FIG. 1 mounted on a transport vehicle.

Referring to FIGS. 1 and 2, the apparatus 100 for extinguishing electric bus fires according to an embodiment of the present disclosure may largely include a fire water tank 110, a foldable frame 120, and a fire water injection lance 130.

The fire water tank 110 is a tank that contains fire extinguishing water to extinguish a fire occurring in a battery of an electric bus, is not limited by storage capacity and can be loaded on a transport vehicle (e.g., truck, etc.), and transported to a fire scene together with the foldable frame 120.

The size or volume of the fire water tank 110 may be changed depending on the loading capacity of the transport vehicle. As an example, a tank with a capacity of 1 ton may be applied.

In addition, in an embodiment, a fire water pump 300 may be placed on one side of the fire water tank 110. The fire water pump 300 supplies the extinguishing water contained in the fire water tank 110 to the fire water injection lance 130, which will be described later, and may produce sufficient water pressure to strongly inject the extinguishing water into a battery located on the roof of an electric bus.

In addition, in an embodiment, the fire water tank 110, the fire water pump 300, and the fire water injection lance 130, which will be described later, may be connected to each other through a fire water supply line. The fire water supply line may be formed to have a sufficient length (e.g., 10 m, etc.) to reach the fire water injection lance 130 from the fire water tank 110.

In addition, in an embodiment, the fire water supply line may be made of a heat dissipation material to prevent the fire water supply line from melting due to the high temperature generated from the battery located on the roof of the electric bus, or may be treated with a heat dissipation coating on the outside.

In addition, although not shown in the drawings, in an embodiment, the fire water supply line may be transported in a circularly wound state using a winch or the like, and may be automatically unwound when the foldable frame 120, which will be described later, is separated from the transport vehicle and transported to the electric bus.

The foldable frame 120 may be transported to the fire scene while mounted on the transport vehicle, then separated from the transport vehicle and attached to the electric bus, and basically, the foldable frame 120 may remain in a folded state and then unfold by means of hydraulic pressure, which will be described as follows.

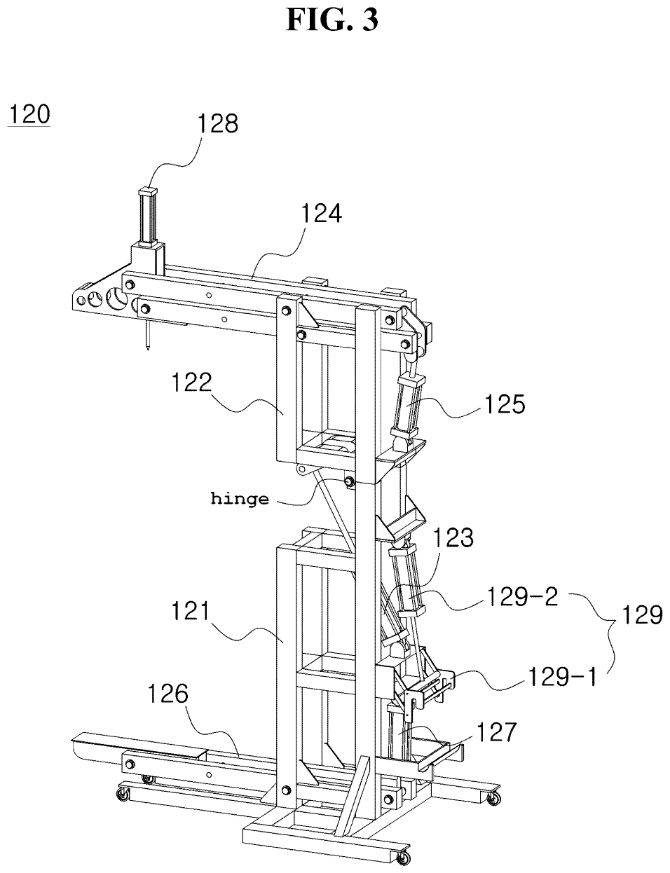

FIG. 3 is a view showing the configuration of the foldable frame 120 in more detail.

Referring to FIG. 3, the foldable frame 120 may largely divided into: a lower frame 121 that is seated on the ground; and an upper frame 122 that is connected to the lower frame 121 with a hinge so as to rotate.

To be specific, the lower frame 121 is seated on the ground and serves to support the foldable frame 120 itself so that the foldable frame 120 does not fall, and a plurality of wheels may be placed on the bottom of the lower frame 121 to facilitate movement.

In addition, in an embodiment, the hinge for rotating the upper frame 122 is disposed on top of the lower frame 121, so that the upper frame 122 may be rotated and erected in the upward direction from the lower frame 121 by means of the hinge. This is to minimize the volume of the foldable frame 120 by folding the upper frame 122 during normal times or when transporting the foldable frame 120, and to rotate the upper frame 122 from the lower frame 121 to raise the upper frame 122 to the height of the electric bus in the process of preparing for fire suppression.

The upper frame 122 is shorter than the lower frame 121 described above or has a length corresponding to the length of the lower frame 121, and is rotated upward from the lower frame 121 to unfold or rotated downward to be folded by means of the hinge.

The upper frame 122 may be rotated from the lower frame 121 by the folding cylinder 123 using hydraulic pressure, which will be described as follows.

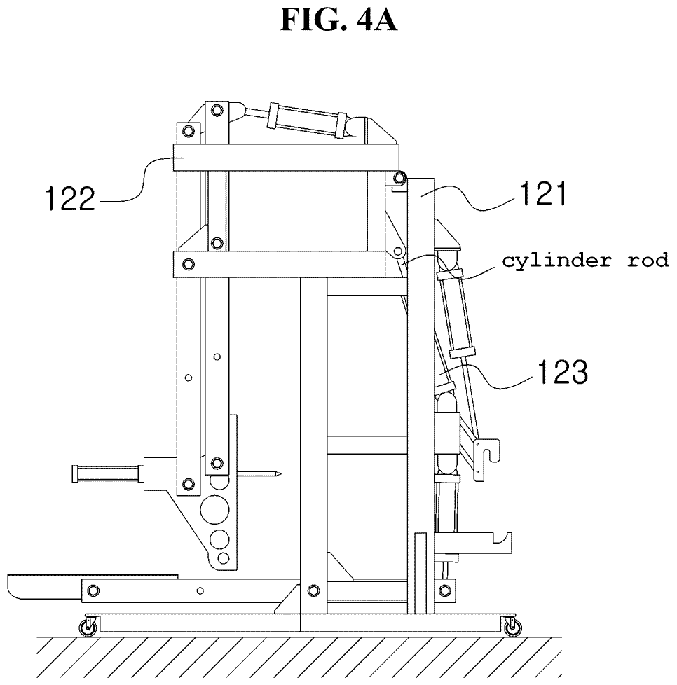

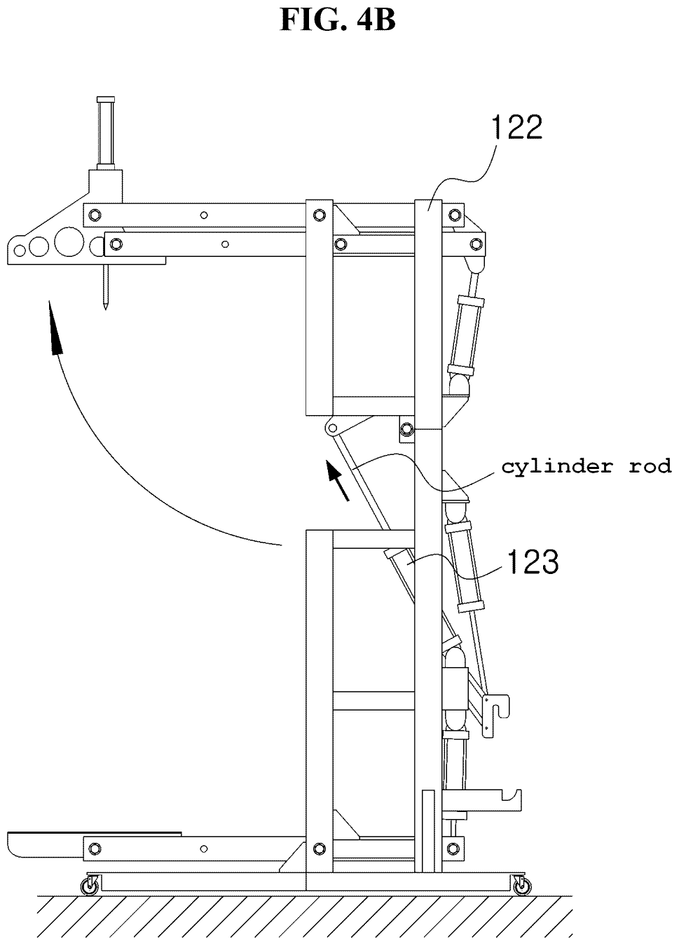

FIGS. 4A and 4B are views showing a state in which the upper frame 122 is rotated from the lower frame 121 by the folding cylinder 123.

Referring to FIGS. 4A and 4B, the upper frame 122 and the lower frame 121 are connected to each other by the hinge, and the upper frame 122 and the lower frame 121 are also connected through the folding cylinder 123. The folding cylinder 123 may be a hydraulic cylinder, and the cylinder length may be reduced using hydraulic pressure to pull the upper frame 122 to stand upright, or the cylinder length may be extended to push the upper frame 122 to fold downward. The folding cylinder 123 is connected to a hydraulic pump 200 disposed on one side of the transport vehicle through a hydraulic supply line and may be controlled by means of hydraulic pressure.

In this case, the hydraulic pump 200 is connected to the folding cylinder 123 through the high-pressure hydraulic supply line, and may hydraulically adjust a cylinder rod length of the folding cylinder 123 to pull the upper frame 122 to stand upright, or to push the upper frame 122 to fold downward.

On the upper side of the upper frame 122, an upper fixing frame 124 is disposed that is connected to the upper frame 122 with a hinge so that one side of the upper fixing frame 124 may rotate, and that is in close contact with the top surface of the electric bus.

The upper fixing frame 124 may be connected to the upper frame 122 by the hinge to have a certain length forward (in the direction toward the electric bus), based on the upright state of the upper frame 122. The lower surface of the upper fixing frame 124 may be in close contact with the top surface of the electric bus, and may be long enough to reach the center of the battery placed on the roof of the electric bus.

In addition, the upper fixing frame 124 may be rotated in the vertical direction from the upper frame 122 by the upper fixing cylinder 125, which will be described as follows.

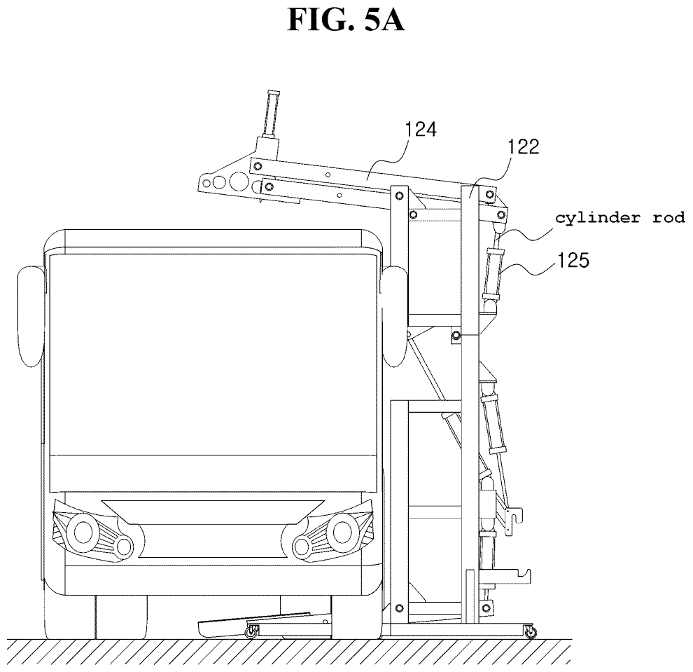

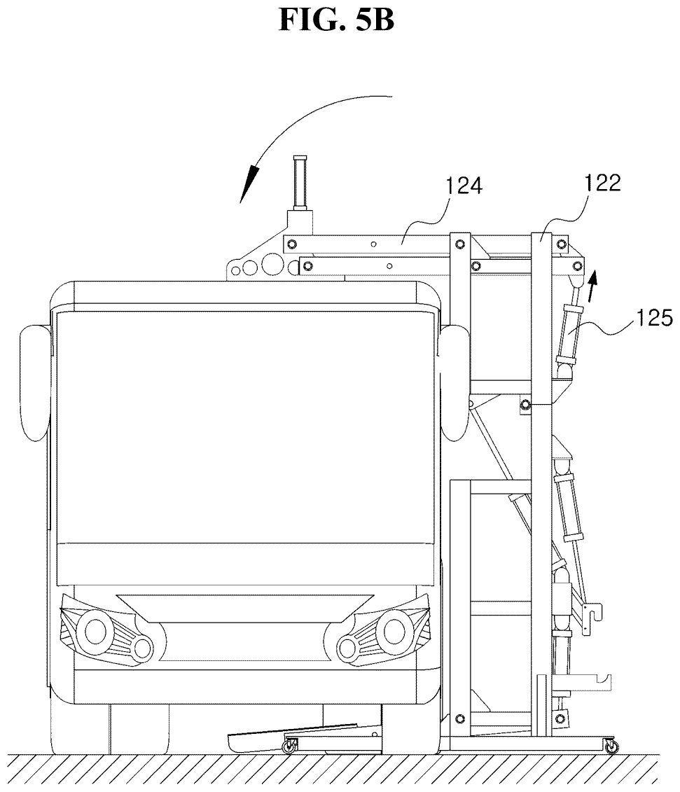

FIGS. 5A and 5B are views showing a state in which the upper fixing frame 124 is rotated from the upper frame 122 by the upper fixing cylinder 125 and is in close contact with the top of the electric bus.

Referring to FIGS. 5A and 5B, the upper fixing frame 124 is connected with the upper frame 122 by the hinge, and the upper fixing frame 124 and the upper frame 122 are connected to each other through the upper fixing cylinder 125. The upper fixing cylinder 125 may be a hydraulic cylinder, and the cylinder length may be reduced using hydraulic pressure to pull the upper fixing frame 124 to be slightly lifted upward, or the cylinder length may be extended to push the upper fixing frame 124 downward to be brought into close contact with the top surface of the electric bus.

That is, after positioning the upper fixing frame 124 on the top surface of the electric bus with the upper fixing frame 124 lifted slightly upward, by lowering the upper fixing frame 124 downward using the upper fixing cylinder 125 so that the upper fixing frame 124 is brought into close contact with the top surface of the electric bus, the foldable frame 120 may be fixed so as not to slide or move in the process of puncturing the battery placed on the roof of the electric bus with the fire water injection lance 130, which will be described later, or injecting high-pressure fire extinguishing water.

The upper fixing cylinder 125 is connected to the hydraulic pump 200 disposed on one side of the transport vehicle through the hydraulic supply line, and may be controlled by means of hydraulic pressure.

The hydraulic pump 200 is connected to the upper fixing cylinder 125 through the high-pressure hydraulic supply line, and adjusts the cylinder rod length of the upper fixing cylinder 125 by using hydraulic pressure to pull and slightly lift the upper fixing frame 124, or to push the upper fixing frame 124 downward so that the lower surface of the upper fixing frame 124 is brought into close contact with the top surface of the electric bus.

In addition, at the end of the upper fixing frame 124, the fire water injection lance 130, which will be described later, may be installed upright to face downward. The fire water injection lance 130 may puncture the battery placed on the roof of the electric bus using hydraulic pressure while the upper fixing frame 124 is in close contact with the top surface of the electric bus, and then inject high-pressure fire extinguishing water into the battery to extinguish the fire, which will be described later.

Meanwhile, corresponding to the upper fixing frame 124, the lower frame 121 is also provided with the lower fixing frame 126 that is in close contact with the bottom surface of the electric bus, which will be described as follows.

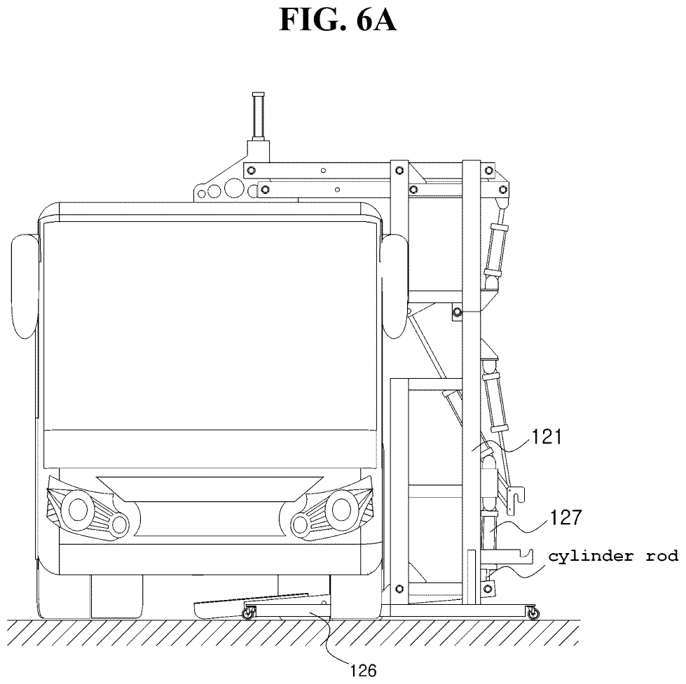

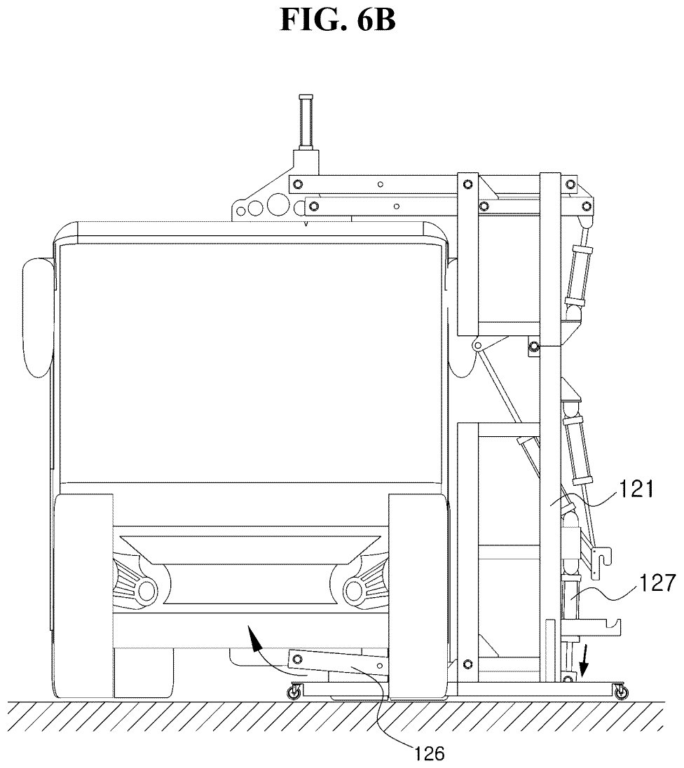

FIGS. 6A and 6B are views showing a state in which the lower fixing frame 126 is rotated from the lower frame 121 by the lower fixing cylinder 127 and is in close contact with the bottom of the electric bus.

Referring to FIGS. 6A and 6B, the lower fixing frame 126 is connected to the lower side of the lower frame 121 by a hinge, and the lower fixing frame 126 and the lower frame 121 are connected to each other through the lower fixing cylinder 127. The lower fixing cylinder 127 may be a hydraulic cylinder, and by means of hydraulic pressure, the cylinder length of the lower fixing cylinder 127 may be reduced to pull the lower fixing frame 126 and lower an end of the lower fixing frame 126 downward, or the cylinder length of the lower fixing cylinder 127 may be extended to push the lower fixing frame 126 and raise the end of the lower upward to be brought into close contact with the bottom surface of the electric bus.

That is, after positioning the lower fixing frame 126 on the bottom surface of the electric bus with the lower fixing frame 126 lowered slightly downward, by lifting the lower fixing frame 126 upward using the lower fixing cylinder 127 so that the lower fixing frame 126 is brought into close contact with the bottom surface of the electric bus, the foldable frame 120 may be fixed so as not to slide or move in the process of puncturing the battery placed on the roof of the electric bus with the fire water injection lance 130, which will be described later, or injecting high-pressure fire extinguishing water.

The lower fixing cylinder 127 is connected to the hydraulic pump 200 disposed on one side of the transport vehicle through the hydraulic supply line, and may be controlled by means of hydraulic pressure.

In addition, in an embodiment, the upper fixing cylinder 125 and the lower fixing cylinder 127 may be controlled simultaneously. For example, when the hydraulic pump 200 applies hydraulic pressure through the hydraulic supply line connected to each of the upper fixing cylinder 125 and the lower fixing cylinder 127, the upper fixing frame 124 connected to the upper fixing cylinder 125 is lifted upward, and the lower fixing frame 126 connected to the lower fixing cylinder 127 is lowered downward, resulting in the upper fixing frame 124 and lower fixing frame 126 being spread apart.

In this state, when the hydraulic direction of the hydraulic pump 200 is switched to the opposite direction while the foldable frame 120 is moved to be adjacent to the side of the electric bus where the fire broke out, the upper fixing frame 124 connected to the upper fixing cylinder 125 comes down toward the top surface of the electric bus to come into close contact with the top surface of the electric bus, and the lower fixing frame 126 connected to the lower fixing cylinder 127 rises toward the bottom surface of the electric bus to come into close contact with the bottom surface of the electric bus.

That is, because the upper fixing frame 124 and the lower fixing frame 126 become closer to each other from being spread apart, the foldable frame 120 may be firmly fixed to the electric bus by tightening the top and bottom parts of the electric bus.

In addition, a puncturing cylinder 128 may be disposed at the end of the upper fixing frame 124 as described above to puncture the battery by pushing the fire water injection lance 130, which will be described later, toward the battery located at the roof of the electric bus, which will be described as follows.

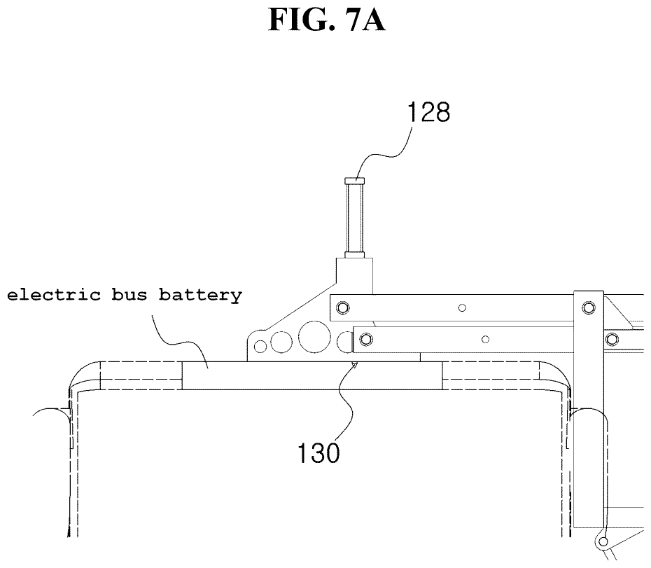

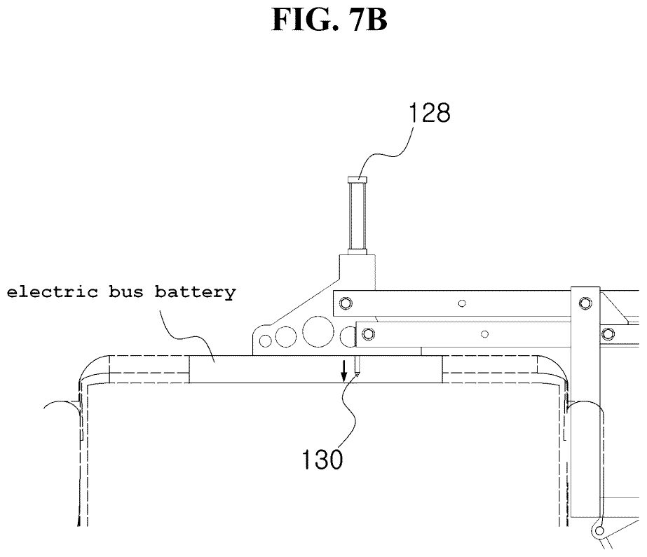

FIGS. 7A and 7B are views showing a state in which the fire water injection lance 130 is inserted toward the inside of a battery by the puncturing cylinder 128 to puncture the battery.

Referring to FIGS. 7A and 7B, in the state where the upper fixing frame 124 described earlier is in close contact with the top surface of the electric bus by the upper fixing cylinder 125, the lower end of the fire water injection lance 130, which is arranged in an upright position at the end of the upper fixing frame 124, is in close contact with the top surface of the electric bus.

In this state, by lowering the fire water injection lance 130 downward using the puncturing cylinder 128, the fire water injection lance 130 is pushed downward by hydraulic pressure and punctures the battery. The puncturing cylinder 128 is connected to the hydraulic pump 200 disposed on one side of the transport vehicle through the hydraulic supply line and may be controlled by means of hydraulic pressure.

In this case, the hydraulic pressure applied from the hydraulic pump 200 to the puncturing cylinder 128 may correspond to a pressure sufficient to puncture the top surface of the electric bus and the battery located thereinside using the fire water injection lance 130.

In this state where the battery at the roof of the electric bus is punctured by the hydraulic pressure applied from the puncturing cylinder 128, fire suppression begins as fire extinguishing water is injected into the battery through the lower side of the fire water injection lance 130.

In addition, in an embodiment, on one side of the foldable frame 120, a mounting part 129 that is formed to be adjustable in height up and down and is mounted on the transport vehicle through a locking connection is disposed, which will be described as follows.

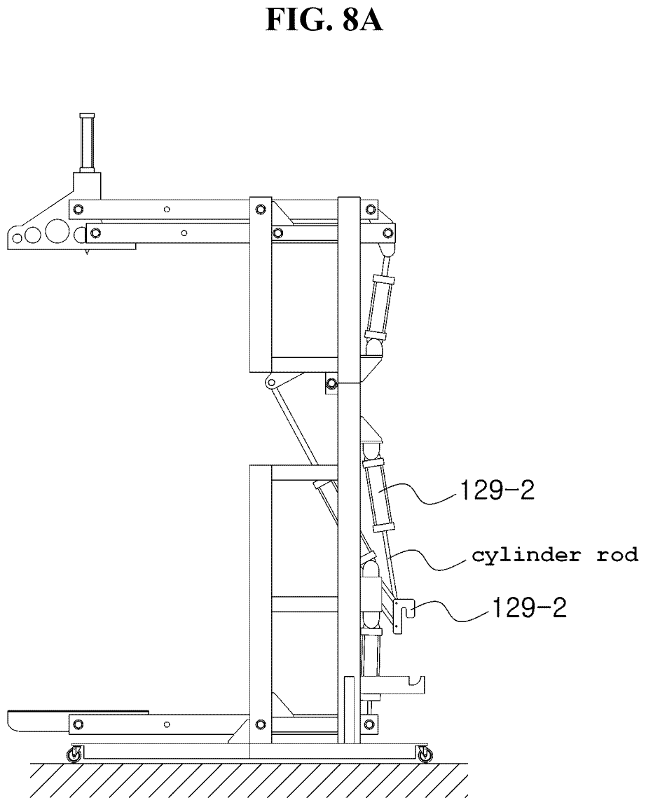

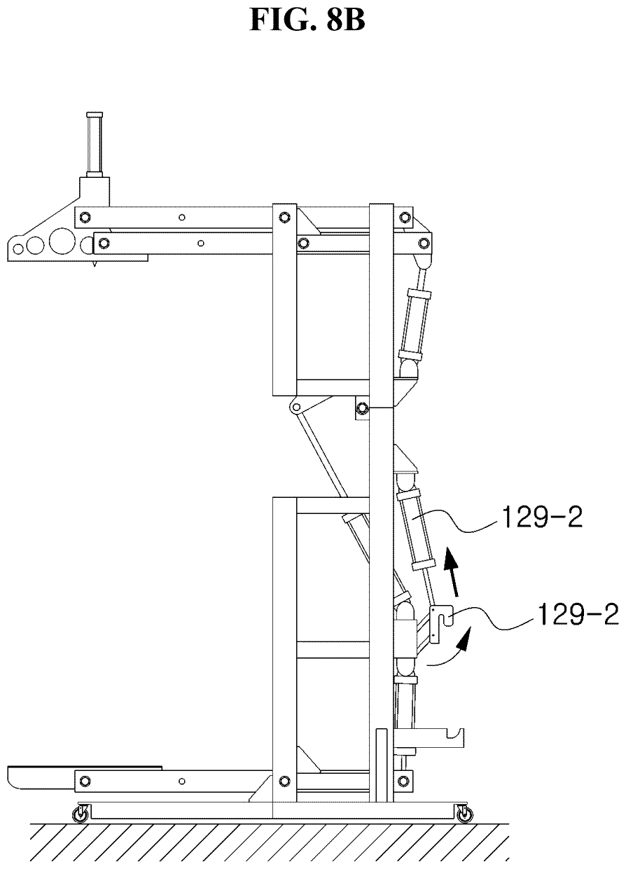

FIGS. 8A and 8B are views showing a state in which the height of a locking means for mounting 129-1 is adjusted up and down from the lower frame 121 by a mounting cylinder 129-2.

Referring to FIGS. 8A and 8B, on the side of the lower frame 121, the mounting part 129 provided so that the height thereof may be adjusted up and down by means of a plurality of hinges, and whose one side is mounted on the transport vehicle through the locking connection.

The mounting part 129 may include: the locking means for mounting 129-1 having a ring shape so as to be mounted on the rear of the transport vehicle (e.g., a truck); and the mounting cylinder 129-2 that adjusts the vertical height of the locking means for mounting 129-1.

The locking means for mounting 129-1 is connected to the side of the lower frame 121 in a form whose height may be adjusted up and down by means of the plurality of hinges, and is connected to the mounting cylinder 129-2 so as to be pulled upward or lowered according to a change in the cylinder length of the mounting cylinder 129-2.

Thus, when the locking means for mounting 129-1 comes into close contact with the rear of the transport vehicle while the mounting cylinder 129-2 pulls the locking means for mounting 129-1 upward by the hydraulic pressure of the hydraulic pump 200, as the hydraulic pressure of the hydraulic pump 200 is applied in the opposite direction, and the cylinder length of the mounting cylinder 129-2 increases, and accordingly, the locking means for mounting 129-1 moves downward and the mounting part 129 is mounted through the locking connection on the rear of the transport vehicle. Due to this, the apparatus 100 for extinguishing electric bus fires may be mounted and transported on the transport vehicle.

On the other hand, to separate the apparatus 100 for extinguishing electric bus fires from the transport vehicle, after pulling the locking means for mounting 129-1 connected to the mounting cylinder 129-2 using the hydraulic pressure of the hydraulic pump 200 to lift the locking means for mounting 129-1 upward, the apparatus 100 for extinguishing electric bus fires may be separated from the rear of the transport vehicle.

The fire water injection lance 130 may be installed in a vertical direction at the end of the upper fixing frame 124 of the foldable frame 120 described above, and the puncturing cylinder 128 described above is disposed on the fire water injection lance 130. Thus, when the puncturing cylinder 128 operates by means of the hydraulic pressure applied from the hydraulic pump 200, the fire water injection lance 130 moves downward and forcibly punctures the battery located at the top of the electric bus, and then fire extinguishing water may be injected into the battery, which will be described as follows.

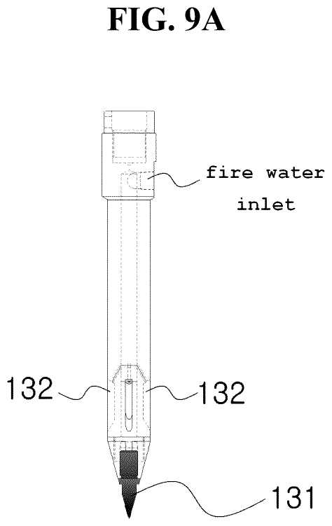

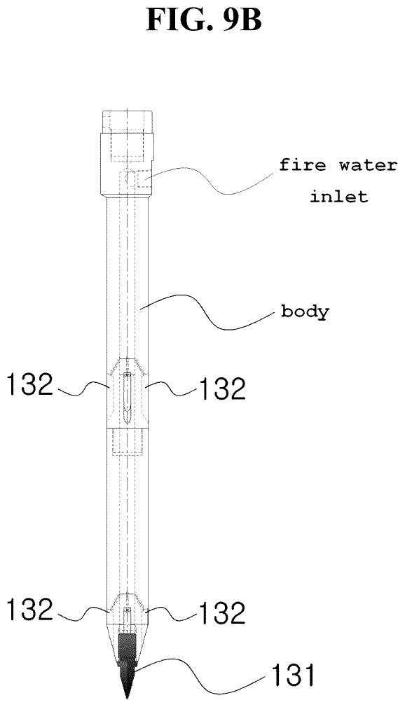

FIGS. 9A and 9B are views showing the fire water injection lance 130 in more detail.

Referring to FIGS. 9A and 9B, the fire water injection lance 130 may include: a lance head 131 that punctures the upper side of the battery and penetrates the battery by using hydraulic pressure; and a fire water nozzle 132 provided on the side of the body of the fire water injection lance 130 and eject fire extinguishing water outward.

To be specific, the lance head 131 has a sharply protruding lower end, and may be made of a material (e.g., alloy, etc.) strong enough to easily penetrate the upper outer wall of the electric bus as well as the upper part of the battery using the hydraulic pressure of the hydraulic pump 200. In addition, in an embodiment, the lance head 131 may be connected to be replaceable from the fire water injection lance 130, and may be configured to be replaced with a new lance head 131 from the fire water injection lance 130 when the end of the lance head 131 becomes blunt or is partially damaged or distorted, resulting in poor performance, such as difficulty penetrating the upper part of the battery.

In addition, a fire water supply line may be connected to the body side of the fire water injection lance 130, and the fire water supply line may be connected to the fire water pump 300 connected to the fire water tank 110 previously mentioned. Thus, fire extinguishing water may be strongly injected through the fire water nozzle 132 by the water pressure applied by the fire water pump 300.

At this time, as shown in FIG. 9B, the body of the fire water injection lance 130 may be formed in multiple stages, and the fire water nozzle 132 may be disposed on the side of each stage.

In addition, an internal supply line may be formed inside the fire water injection lance 130 for injecting the fire extinguishing water supplied through the fire water supply line.

Next, the entire process of transporting the apparatus for extinguishing electric bus fires 100 described above to the electric bus fire scene by the transport vehicle and extinguishing the fire is explained in order.

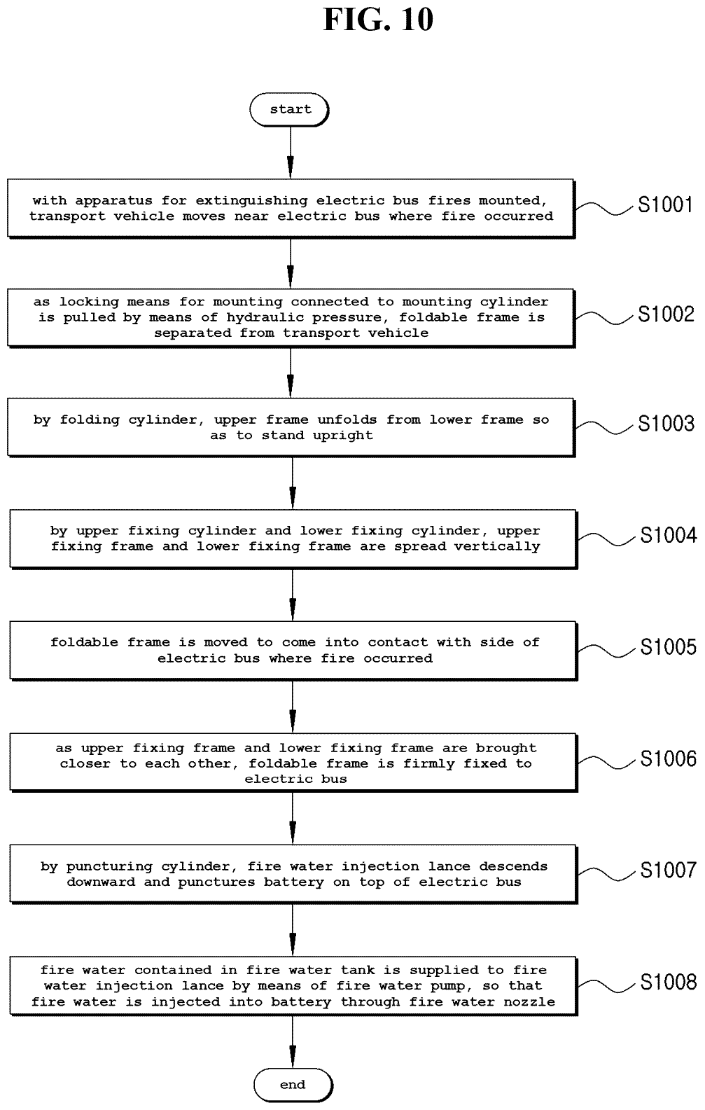

FIG. 10 is a view sequentially showing the process of extinguishing a fire in an electric bus battery using the apparatus 100 for extinguishing electric bus fires.

Referring to FIG. 10, with the apparatus for extinguishing electric bus fires 100 mounted on the transport vehicle, the transport vehicle moves near the electric bus where the fire occurred (S1001), and after the locking means for mounting 129-1 connected to the mounting cylinder 129-2 is pulled by means of the hydraulic pressure of the hydraulic pump 200, the foldable frame 120 is separated from the transport vehicle (S1002).

In this state, the hydraulic pump 200 applies hydraulic pressure to the folding cylinder 123 to unfold the upper frame 122 from the lower frame 121 so as to stand upright (S1003). At the same time, the hydraulic pump 200 applies hydraulic pressure to the upper fixing frame 124 and the lower fixing frame 126, thereby causing the ends of the upper fixing frame 124 and the lower fixing frame 126 to spread apart (S1004).

Next, when the foldable frame 120 itself comes into contact with the side of the electric bus where the fire occurred (S1005), the hydraulic pump 200 applies hydraulic pressure to the upper fixing frame 124 and the lower fixing frame 126 in opposite directions to bring the ends of the upper fixing frame 124 and the lower fixing frame 126 closer to each other, so that the foldable frame 120 is firmly fixed to the electric bus and does not move (S1006).

In this state, the hydraulic pump 200 applies hydraulic pressure to the puncturing cylinder 128 to push the fire water injection lance 130 downward, thereby puncturing the battery (meaning the battery in a thermal runaway state) provided on the roof of the electric bus (S1007).

Next, the fire water pump 300 supplies the fire extinguishing water contained in the fire water tank 110 to the fire water injection lance 130, so that the strong water pressure causes the fire extinguishing water to be injected into the battery through the fire water nozzle 132 of the fire water injection lance 130 to extinguish the fire (S1008). After the fire suppression is completed, steps S1001 to S1008 described above are performed in reverse, and the apparatus may be transported again via the transport vehicle.

Although the present disclosure has been described herein in relation to some embodiments, various modifications and changes may be made without departing from the scope of the present disclosure as understood by those skilled in the art to which the present disclosure pertains. Additionally, such modifications and changes should be considered to fall within the scope of the claims appended hereto.

What is claimed is:

1. An apparatus for extinguishing electric bus fires, the apparatus comprising:
a fire water tank (110) provided in a transport vehicle;
a foldable frame (120) configured to unfold or fold using hydraulic pressure; and
a fire water injection lance (130) disposed on the foldable frame (120), and configured to puncture a battery placed on a roof of an electric bus and inject fire extinguishing water supplied from the fire water tank (110) into the battery,
wherein the foldable frame (120) is positioned, while unfolded, adjacent to a side of the electric bus, and with the foldable frame (120) fixed to the side of the electric bus, the fire water injection lance (130) punctures the battery placed on the roof of the electric bus by using the hydraulic pressure and injects the fire extinguishing water into the battery to extinguish a fire.

2. The apparatus of claim 1, wherein the foldable frame (120) comprises:
a lower frame (121);
an upper frame (122) connected to the lower frame (121) with a hinge so that a side thereof can be rotated;
a folding cylinder (123) connected between the lower frame (121) and the upper frame (122) and configured to control a rotation of the upper frame (122) by using the hydraulic pressure;
an upper fixing frame (124) connected to the upper frame (122) with a hinge so that a side thereof can be rotated, and in close contact with a top surface of the electric bus;
an upper fixing cylinder (125) connected between the upper frame (122) and the upper fixing frame (124), and configured to control a rotation of the upper fixing frame (124) by using the hydraulic pressure;
a lower fixing frame (126) connected to the lower frame (121) with a hinge so that a side thereof can be rotated, and in close contact with a bottom surface of the electric bus;
a lower fixing cylinder (127) connected between the lower frame (121) and the lower fixing frame (126), configured to control a rotation of the lower fixing frame (126) by using the hydraulic pressure; and
a puncturing cylinder (128) disposed at an end of the upper fixing frame (124), and configured to push the fire water injection lance (130) located at a top of the electric bus toward the battery.

3. The apparatus of claim 2, wherein the foldable frame (120) further comprises:
a mounting part (129) provided to be adjustable in height up and down while connected to a side of the lower frame (121), and a side of which is mounted on the transport vehicle through a locking connection.

4. The apparatus of claim 3, wherein the mounting part (129) comprises:
a locking means for mounting (129-1) having a ring shape so as to be mounted on the transport vehicle; and
a mounting cylinder (129-2) connected between the lower frame (121) and the locking means for mounting (129-1), and configured to adjust a vertical height of the locking means for mounting (129-1) by using the hydraulic pressure.

5. The apparatus of claim 4, wherein the folding cylinder (123), the upper fixing cylinder (125), the lower fixing cylinder (127), the puncturing cylinder (128), and the mounting cylinder (129-2) are connected to a hydraulic pump (200) disposed on a side of the transport vehicle through a hydraulic pressure supply line and controlled by means of the hydraulic pressure.

6. The apparatus of claim 5, wherein by means of the hydraulic pressure supplied from the hydraulic pump (200), the folding cylinder (123), the upper fixing cylinder (125), the lower fixing cylinder (127), the puncturing cylinder (128), and the mounting cylinder (129-2) are each independently controlled.

7. The apparatus of claim 1, wherein the fire water injection lance (130) is connected to a fire water pump (300) disposed on a side of the fire water tank (110) through a fire water supply line and receives the fire extinguishing water.

8. The apparatus of claim 7, wherein the fire water injection lance (130) comprises:
a lance head (131) configured to puncture an upper side of the battery by using the hydraulic pressure; and
a fire water nozzle (132) provided on a side of a body of the fire water injection lance (130) and configured to eject the fire extinguishing water outward,
wherein the lance head (131) is connected to be replaceable from the body of the fire water injection lance (130).

9. The apparatus of claim 8, wherein the body of the fire water injection lance (130) is formed in multiple stages, and the fire water nozzle (132) is disposed in each stage.
